(19) United States
(12) Patent Application Publication
(10) Pub. No.: US 2013/0254757 A1
(43) Pub. Date: Sep. 26, 2013

(54) NESTING INSTALLATIONS OF SOFTWARE PRODUCTS

(71) Applicants: SHENOL YOUSOUF, Sofia (BG); GEORGI STANEV, Sofia (BG); KATYA TODOROVA, Sofia (BG)

(72) Inventors: SHENOL YOUSOUF, Sofia (BG); GEORGI STANEV, Sofia (BG); KATYA TODOROVA, Sofia (BG)

(21) Appl. No.: 13/427,859

(22) Filed: Mar. 22, 2012

(51) Int. Cl. G06F 9/445

(52) U.S. Cl. 717/174

(57) ABSTRACT

In one aspect, a new software application building upon a base software product is created. A definition of a new software product is generated including the new software application. A reference to the base software product is included in the definition of the new software product. In another aspect, an installable package for the new software product is generated based on the definition and stored in a public repository. In yet another aspect, the installable package of the new software product includes a reference to an installable package of the base software product to enable customers installing the new software product with nesting an installation of the base software product.

### BACKGROUND

The development of new computer applications is often based on existing, previously developed software. For example, it is a common practice to reuse already created software components or even entire applications in the new computer applications. Generally, new functionalities build on top of, or extend an existing software product or platform. Such base software products or platforms are prerequisite for the implementation of the new functionalities, and may be provided by third parties. Furthermore, a computer application may be developed based on more than one available products or platforms, including alternative products or platforms, provided by different vendors. Therefore, the installation of new application often requires the installation and setup of one or more prerequisite software products and/or platforms.

The distribution and installation of computer applications based on existing software products or platforms could be a cumbersome task. One of the approaches is to package the code and the deployment information of the new applications together with the code and the deployment information of the prerequisite or base products. Thus a complete installation delivery of the new application is created, e.g., as a new product. Alternatively, customers may be required to install the base products first as delivered by the respective vendors. However, there are numerous weaknesses of either of these approaches, especially when the prerequisite products are delivered by third parties. For example, a base product may be altered by its vendor after the generation of the installation package, or a reconfiguration of one or more of the components of the base product may be necessary. Accordingly, to update the base product, a new installable package of the whole new product, including the new application has to be generated and delivered to the customer.

### BRIEF DESCRIPTION OF THE DRAWINGS

The claims set forth the scope with particularity. The embodiments are illustrated by way of example and not by way of limitation in the figures of the accompanying drawings in which like references indicate similar elements. The embodiments, together with its advantages, may be best understood from the following detailed description taken in conjunction with the accompanying drawings.

FIG. 1A is a block diagram illustrating a computer system landscape of nested product installation, according to one embodiment.

FIG. 1B is a block diagram illustrating a computer system landscape of nested product installation, according to one embodiment.

FIG. 1C is a block diagram illustrating a computer system landscape of nested product installation, according to one embodiment.

FIG. 2 is a block diagram illustrating a software product structure, according to one embodiment.

FIG. 3 is a block diagram illustrating a landscape for definition and nesting installations of software products, according to one embodiment.

FIG. 4 is a flow diagram illustrating a process for generating and publishing installable packages, according to one embodiment.

FIG. 5 is a flow diagram illustrating a process for generating and publishing installable packages, according to one embodiment.

FIG. 6A is a block diagram illustrating a metadata structure of a product installable package, according to one embodiment.

FIG. 6B is a block diagram illustrating a metadata structure of a product installable package, according to one embodiment.

FIG. 7 is a block diagram of an exemplary computer system for nesting installations of software products, according to one embodiment.

### DETAILED DESCRIPTION

Embodiments of techniques for nesting installations of separate software products are described herein. In the following description, numerous specific details are set forth to provide a thorough understanding of the embodiments. One skilled in the relevant art will recognize, however, that the presented ideas can be practiced without one or more of the specific details, or with other methods, components, materials, etc. In other instances, well-known structures, materials, or operations are not shown or described in detail to avoid obscuring.

Reference throughout this specification to “one embodiment”, “this embodiment” and similar phrases, means that a particular feature, structure, or characteristic described in connection with the embodiment is included in at least one embodiment. Thus, the appearances of these phrases in various places throughout this specification are not necessarily all referring to the same embodiment. Furthermore, the particular features, structures, or characteristics may be combined in any suitable manner in one or more embodiments.

Usually, a new software application is delivered to customers for installation in the form of a standalone installable package. Such an installable package may pose a set of requirements for a computer system environment where the application will be deployed and executed. In one embodiment, the installation and execution of the new application may further require installation of one or more other applications, or even software products, that provide specific functionalities or program components reused by the new application.

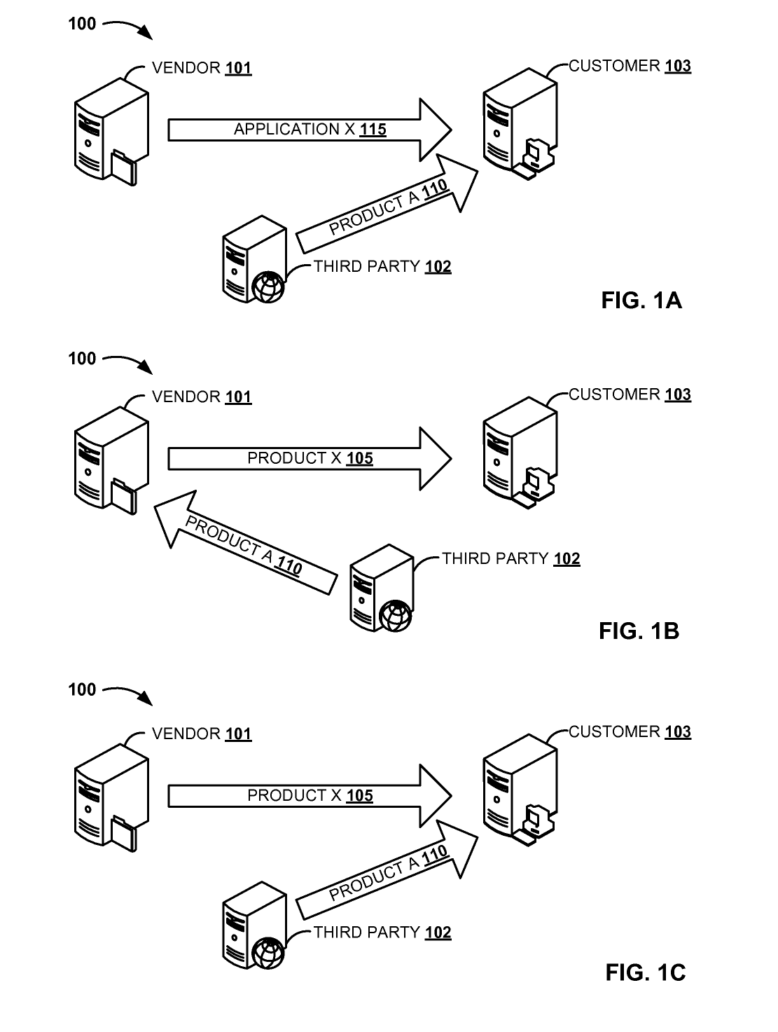

FIG. 1A shows computer system landscape 100 that illustrates a dependency of the installation of a new application, e.g. application ‘X’ 115 delivered to customer 103 by vendor 101 on another application, e.g., on product ‘A’ 110 delivered by third party vendor 102. In one embodiment, application ‘X’ 115 provides new functionality built upon the software components and functionality of product ‘A’ 110. For example, product ‘A’ 110 could be a web server, and application ‘X’ 115 could be an application providing web services, e.g., web searching, messaging, social networking, etc. Customer 103 should first install product ‘A’ 110 delivered by third party 102, and then application ‘X’ 115 on top of product ‘A’ 110 to implement the necessary functionality. In one embodiment, the requirement to install product ‘A’ 110 as a prerequisite for the installation of application ‘X’ 115 may be communicated to the customer 103 separately.

In one embodiment, vendor 101 and/or third party 102 can upload application ‘X’ 115 and/or product ‘A’ 110 on one or more locations accessible by the customer 103, e.g., each referenced by corresponding uniform resource identifier (URI) or uniform resource locator (URL). Thus, the customer 103 may first download and install product ‘A’ 110 from third party 102 URL, and then install application ‘X’ 115 from vendor 101 URL on top or in combination with product ‘A’ 110.

There are scenarios where customer 103 may not be aware that the preliminary installation of product ‘A’ 110 is required to install and run application ‘X’ 115. Even if customer 103 is aware that product ‘A’ 110 is necessary, it may be cumbersome to synchronize the installations of product ‘A’ 110 and application ‘X’ 115. For example, application ‘X’ 115 may require certain components or features of product ‘A’ 110 having specific configuration that may differ from the default. Thus, the separate installations of product ‘A’ 110 and application ‘X’ 115 may require heavy administration and is prone to errors and inefficiency.

FIG. 1B shows computer system landscape 100 where the application ‘X’ is defined as self-contained installable entity, including the prerequisite software components, e.g., of product ‘A’ 110, according to one embodiment. The self-contained definition of application ‘X’ is illustrated with product ‘X’ 105. Product ‘X’ 105 could be downloaded and installed at customer 103 from vendor 101 URL. To avoid inefficiency and unnecessary administration, product ‘X’ 105 packages a reference to the software code (e.g., binaries) and configuration (e.g., metadata) of the prerequisite product ‘A’ 110 necessary for the implementation of application ‘X’.

In one embodiment, the binaries and configuration of product ‘A’ 110 provided by third party 102 are mirrored at vendor 101 URL, e.g., in an installation delivery repository. Only a reference to product ‘A’ 110 and new configuration or setup of one or more, if any, of its software components are included in the definitions of product ‘X’ 105. Thus, whenever third party 102 makes changes to product ‘A’, they are directly reflected in product ‘X’ 105. Customer 103 receives access to the most recent installation of product ‘A’ 110 mirrored on the single location of vendor 101. In an alternative embodiment, the installation package of product ‘A’ is not mirrored to the location of vendor 101. Instead, the definition of product ‘X’ includes reference to the installation deliverables of product ‘A’ 110 directly placed on a location provided by the third party 102, or in another public repository, as illustrated with FIG. 1C.

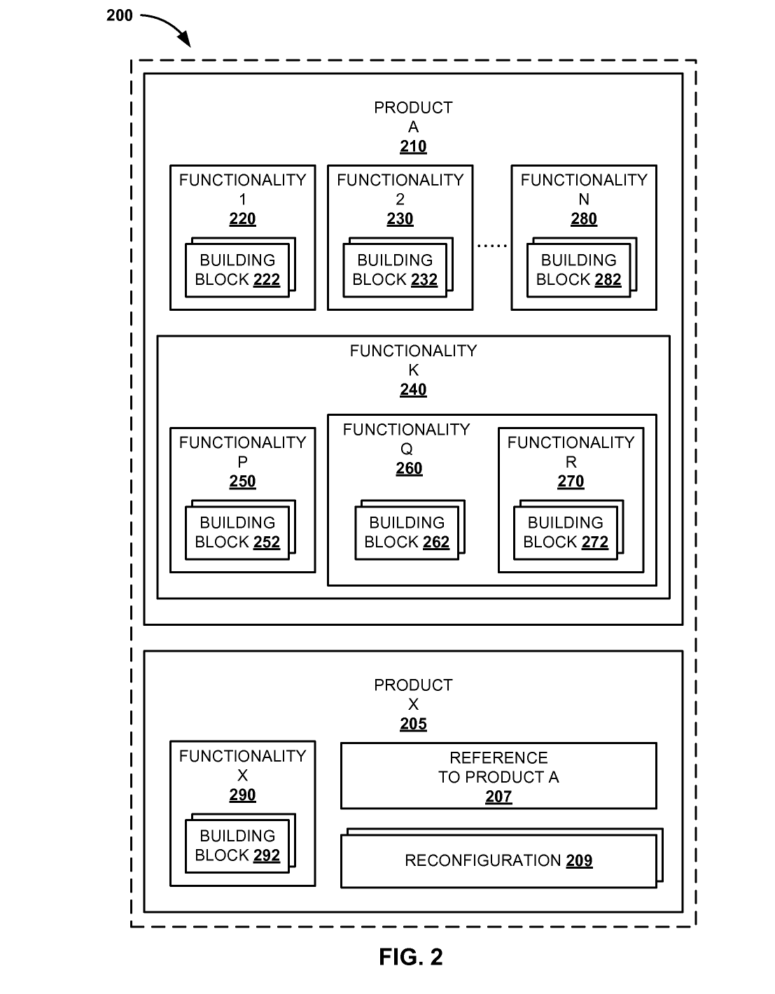

FIG. 2 sketches an exemplary software product structure 200, according to one embodiment. According to one definition, a software product is a self-contained entity installable and executable on a specified type or types of computer system hardware and software (e.g., operation system). A product is a framework or a shell including one or more functionalities, e.g., applications or features that operate in a synchronized manner to provide different services. A description of a product may provide metadata, configuration and even source code necessary for the installation and setup (e.g., the deployment) of the product and the included functionalities. Once installed in a computer system landscape, a product could be independently managed, e.g., configured, started, stopped, accessed, etc. The different functionalities of a product cannot be installed standalone or managed independently, as the product description, e.g., the product shell, provides the necessary means to access the functionalities, such as, interfaces, dependencies, relationships, etc. In one embodiment, the product provides the necessary runtime environment to execute the applications.

FIG. 2 illustrates base product ‘A’ 210 that encompasses a number of functionalities, including functionality ‘1’ 220, functionality ‘2’ 230, functionality ‘K’ 240, functionality ‘P’ 250, functionality ‘0’ 260, functionality ‘R’ 270 and functionality ‘N’ 280. A functionality may be determined by one or more building blocks, such as building blocks 222, 232, 252, 262, 272 and 282, accordingly. A building block may represent a logically, functionally or programmatically distinct software component providing a particular element or characteristic of the corresponding functionality. In one embodiment, functionality may correspond to a separate application of a product. For example, if product ‘A’ 210 is a webserver, functionality ‘1’ 220 may provide user authentication service, functionality ‘2’ 230 may provide email service, functionality ‘K’ 240 may provide a number of social networking services, etc.

The different functionalities of a product may be related to and dependent on each other. In one embodiment, a hierarchy may be defined between the functionalities, where one functionality is subordinate to, dependent on or included in, another functionality. As FIG. 2 shows, functionality ‘R’ is included in functionality ‘Q’ 260, which in turn is subordinate to functionality ‘K’ 240 together with functionality ‘P’ 250. For example, functionality ‘P’ 250 could provide messaging service as part of the social network services provided by functionality ‘K’ 240.

Further, FIG. 2 shows a new application, e.g., functionality ‘X’ 290 that builds upon product ‘A’ 210. In other words, the installation and execution of functionality ‘X’ 290, and respectively the building blocks 292 of functionality ‘X’ 290, depend on a preliminary or simultaneous installation of product ‘A’ 210. For example, functionality ‘X’ 290 could be an online shopping solution that needs the user authentication service of functionality ‘1’ 220, and the webserver product ‘A’ 210 provides the runtime environment for both functionality ‘1’ 220 and the new functionality ‘X’ 290. Accordingly, functionality ‘X’ 290 cannot be installed as a standalone computer application. First, product ‘A’ 210 or alternative webserver product should be installed, then the installation of functionalities ‘X’ 290 and ‘1’ 220, e.g., the shopping solution and the authentication application, could commence. Accordingly, functionality ‘X’ 290 may be included in product ‘A’ 210, or a new product could be defined including functionality ‘X’ 290 and the necessary components of product ‘A’ 210, e.g., the functionalities and building blocks 220 to 282.

In one embodiment, product ‘X’ 205 is defined to include functionality ‘X’ 290 and a reference 207 to product ‘A’ 210. The definition of product ‘X’ 205 may also include reconfigurations 209 of one or more of the elements of product ‘A’ 210 (functionalities and building blocks 220 to 282). For example, the online shopping solution represented by functionality ‘X’ 290 could be described as the new standalone and self-contained product ‘X’ 205, where the prerequisite webserver (product ‘A’ 210) is included in the description of product ‘X’ 205 by reference 207, without copying the definitions and the descriptions of product ‘A’ 210 and its components 220 to 240, except for the differences (the reconfigurations 209). Thus, an installation of product ‘X’ 205 may first install product ‘A’ 210 as nested software product installation, then setup one or more, if any, of its components according to reconfigurations 209, and finally install functionality ‘X’ 290 and its building blocks 292.

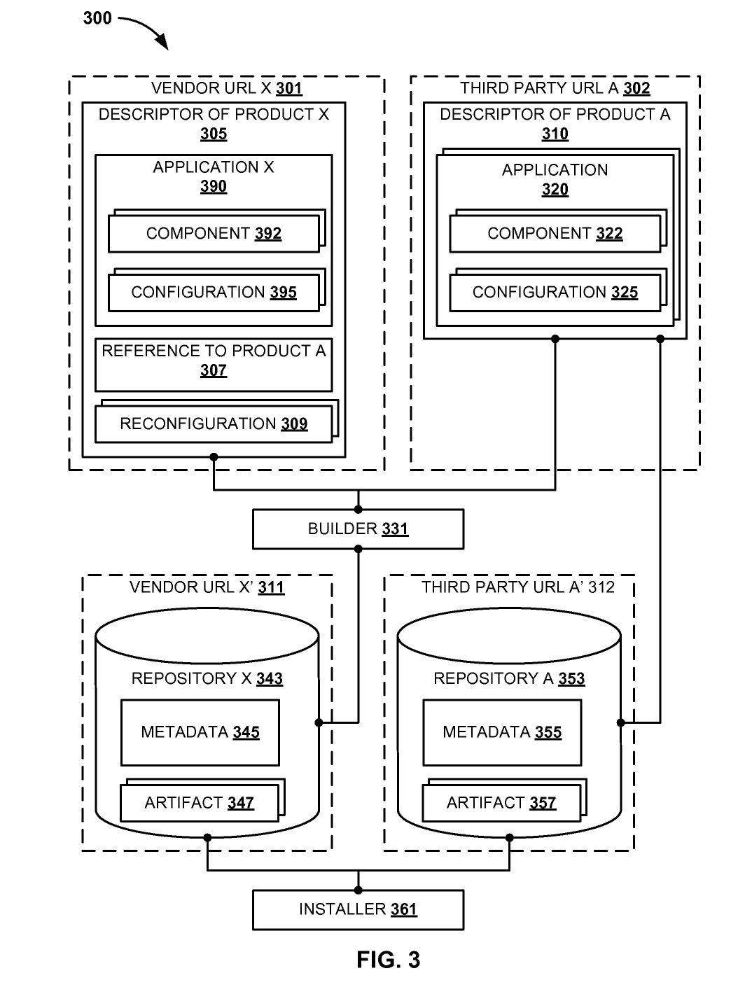

FIG. 3 shows landscape 300 for definition and nesting installation of software products, according to one embodiment. Descriptor of product ‘X’ 305 provides definition of product ‘X’ including application ‘X’ 390 and reference to the base product ‘A’ 307. The definition of application ‘X’ 390 in descriptor 305 may specify components 392 and default configurations 395, e.g., the setup of the components 392, their relationships, default parameters, required dependencies, etc. Reconfigurations 309 may define new setup for one or more components or parameters of product ‘A’ identified with the reference 307. The descriptor of product ‘X’ 305 may be accessible at vendor URL ‘X’ 301.

Similar to descriptor of product ‘X’ 305, descriptor of product ‘A’ 310 includes definitions of applications 320 as part of product ‘A’, and configurations 325 of the product ‘A’ and the components 322 of product ‘A’. Descriptor of product ‘A’ 310 may be available at third party URL ‘A’ 302.

In one embodiment, descriptors 305 and 310 are used to generate installation packages for products ‘X’ and ‘A’, or a single installation package for product ‘X’. In either case, the installation of product ‘A’ is nested in the installation of product ‘X’ as prerequisite for the implementation of application ‘X’ 390, according to the descriptor of product ‘X’ 305. In one embodiment, builder 331 accesses the description of product ‘X’ 305 and the description of product ‘A’ 310 to generate an installation package for application ‘X’ 390 and to publish it in repository ‘X’ 343.

Generally, the installation package may include metadata 345 and artifacts 347. In one embodiment, the metadata 345 includes metadata for both product ‘X’ and product ‘A’. Usually, the metadata contains useful installation and execution information about the components (e.g., functionalities and building blocks) of products ‘A’ and ‘X’. For example, metadata 345 may contain identifications of the different components that have to be installed; properties, relationships and dependencies of these components; configuration information, etc. The artifacts 347 may contain the installable source code of the components of the nested products ‘A’ and ‘X’. For example, repository ‘X’ 343 may store artifacts 347 as resource archives, e.g., in binary form. Repository ‘X’ 343 may be accessible at vendor URL ‘X’ 311. In one embodiment, vendor URL ‘X’ 301 and vendor URL ‘X’ 311 may refer to the same location. Either vendor URL ‘X’ 301 or vendor URL ‘X’ 311, or both, may refer to public locations that are not owned or administered by the vendor or the provider of product ‘X’.

In one embodiment, the installable package generated by builder 331 and published in repository ‘X’ 343 at vendor URL ‘X’ 311 may not contain the default metadata and the artifacts of product ‘A’. The metadata 345 may include a reference to a location where the installable package of product ‘A’ is stored, e.g., repository ‘A’ 353 at third party URL ‘A’ 312. The installable package of product ‘A’, including metadata 355 and artifacts 357 may be maintained and updated by a third party. For example, a provider of a webserver (product ‘A’) may publish a distribution of a latest release of the webserver at a public location, e.g., third party URL ‘A’ 312. Thus, the customers of product ‘X’ will be sure that they always install the latest version of product ‘A’. The installation of product ‘X’ and the nested product ‘A’ could be performed at a customer, e.g., using installer 361 tool, based on the installation package in repository ‘X’ 343, or based on the installation packages in both repositories ‘X’ 343 and ‘A’ 353, accordingly.

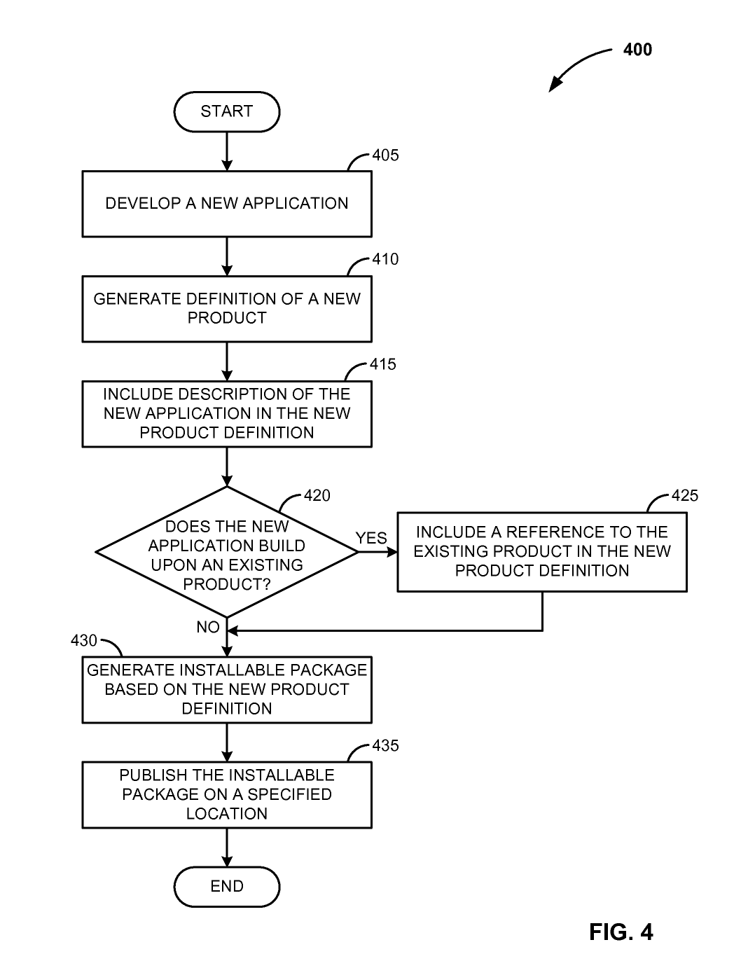

FIG. 4 shows process 400 for generating and publishing installable package of a software application, according to one embodiment. A new software application is developed at 405. At 410, a definition of a new product corresponding to the new application is generated, and, at 415, a description of the new application is included in the definition of the new product. In one embodiment, the definition of the new product provides the necessary branding or packaging of the functionalities and/or the components of the new application. Further, the new product may define the non-reusable aspects of the new application to allow a self-contained implementation, such as, but not limited to, system screens, help content, specific icons, preferences, etc. The new product definition may also include default properties and parameter values for the application components. Without such branding and default setup, it may not be possible to install, refer and execute the new application.

At 420, a check is performed to verify whether the new application builds upon an existing product. Very rarely an application, especially a business or commercial application, is developed without reusing certain components or functionalities provided by existing software applications or products. Usually, the newly developed applications extend already existing software solutions. One very simple example is the need to install and run operating system to a computer to allow the installation of other applications.

When the check at 420 shows that the newly developed application builds upon an existing (e.g., base) product, a reference to this product is included in the new product definition at 425. For example, if the new application is a web based application, the base product may be a webserver. There are a number of webserver products available for download and installation. Therefore, the reference included in the new product definition may specify one such webserver product. In one embodiment, the reference to the base product may contain minimum required information to identify the base product and a location from where a distribution of the base product can be obtained.

At 430, installable package is generated for the new application based on the new product definition. In one embodiment, the installable package may include source code of the different components of the new application. Further, the installable package may include metadata describing the components of the new product, how the components interact, the default properties of the available artifacts, some installation requirements, update procedures, etc. Depending on the implementation of process 400, the installable package generated at 430 may include the artifacts, e.g., the source code, and the pertinent metadata of the base product. Alternatively, the installable package may refer to a location where an installable package for the base product is available. The installable package generated at 430 may include only reconfiguration metadata for one or more (if any) of the components of the base product. At 435, the generated installable package is published on a specified location.

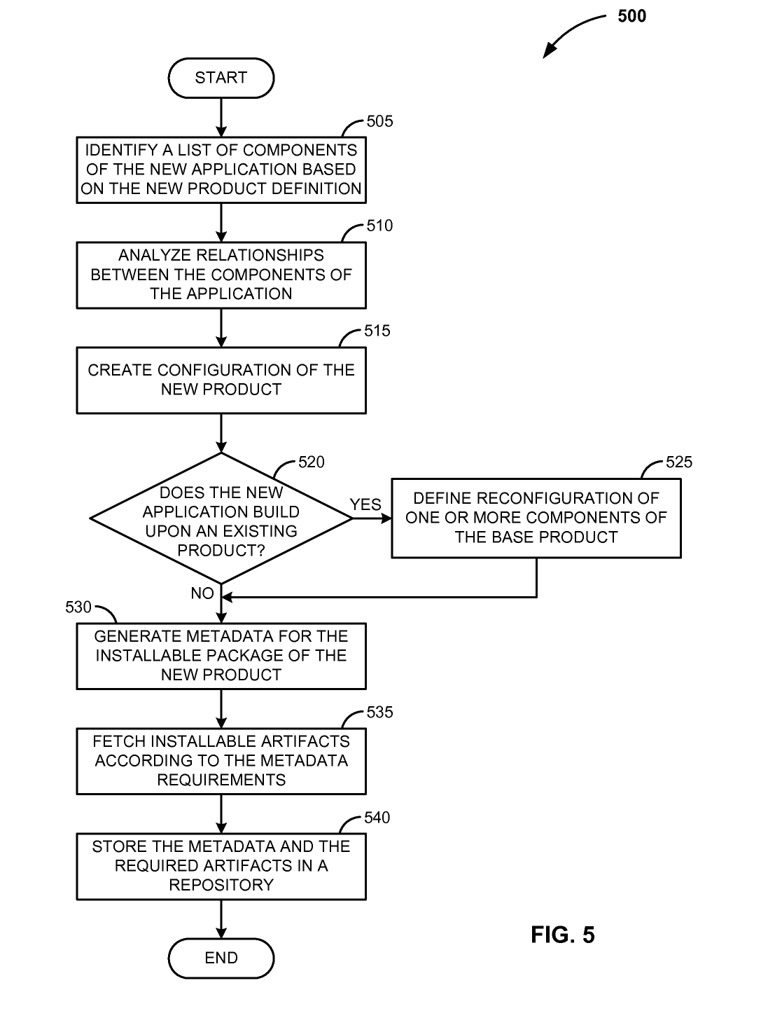

FIG. 5 illustrates process 500 showing further details for generating and publishing installable packages based on nested product definitions. In one embodiment, a list of components of a new application is identified based on a new product definition at 505. For example, the definition of the new product may include identification information encompassing a subset of a number of software components available at a specified location. In one embodiment, the list of components may include unitary components or building blocks, and composite components, where the composite components combine more than one unitary components to provide certain functionality of the application.

At 510, the relationships and the dependencies existing between the different components of the new application are analyzed. The relationships between the application components may be defined during their development and/or their configuration. For example, two or more application components may have to be executed in a specific order; the result of the execution of one component may be a condition for the execution of another; two or more unitary components may be related in a composite component; etc.

The configuration of the new product is created at 515. For example, the configuration provides information used to specify and install the necessary components the application includes, to establish the necessary dependencies and relationships between the components, to initialize parameters and properties or the application or its components, to configure the runtime environment, etc.

At 520, a check is performed to verify whether the new application builds upon or enhances an existing, e.g., base, product. When such base product is identified, a new configuration or reconfiguration for the base product or for one or more of its components may be defined at 525. The execution of steps 505 to 525 of process 500 provides the information necessary to generate the metadata to be included in the installable package for the new product at 530. In one embodiment, the metadata provides description of the components of the new application, their relationships, dependencies, configuration, etc.

At 535, the installable artifacts corresponding to the components of the new product are fetched according to the metadata requirements. For example, the necessary artifacts are searched in one or more pools or resources containing a number of available artifacts. In one embodiment, particular versions of the artifacts are selected as specified in the metadata. Often, the customers do not know what components, base products or configurations the application needs in order to correctly and efficiently provide the services requested by the customers. In one embodiment, the metadata and the fetched artifacts form the installable package to ensure the necessary installable components, and to bring them together with the right configuration for a particular execution environment. In one embodiment, the necessary installable components could be a subset of the fetched artifacts depending on particular customer needs and/or the target execution environment.

At 540, the metadata and the required artifacts are stored as an installable package in a repository. For example, the installable package may be placed at a public network address, from where the new product may be downloaded and installed by customers. In one embodiment, the installable package may be placed in a repository, e.g., a URL accessible location, in a predefined format. The format may specify how the metadata and the installable artifacts are organized and described, as well as the structure of the data container where the metadata and the artifacts are stored. For example, an adopted convention may require the installable package of the new product to be placed in a number of files with different format. Thus, the metadata may be included in a file with eXtensible Markup Language (XML) format, and the artifacts may be included in one or more Java® ARchive (JAR or .jar) binary files. The different files may be stored in one or more file system folders.

The described mechanisms for nesting installations of software products could be implemented in various types of computer system landscapes, including various development and runtime environments. One example for such implementation is the p2® provisioning platform for Eclipse®-based applications. Eclipse® is an open source community, whose projects are focused on building an open development platform comprised of extensible frameworks, tools and runtimes for building, deploying and managing software across the lifecycle.

Eclipse® development platform enables adding extensions such as plug-ins that provide functionalities for the software development tools created and used by the community. Software developers, including commercial vendors, can build, brand, and package products using the platform as a base technology. These products can be sold and supported commercially. Therefore, the efficient provisioning of the developed products is especially important. Eclipse® provides software development kit (SDK) that can be downloaded and used as Java® integrated development environment. By adding various enhancement, the Eclipse® platform could be used to develop applications in various programming languages, such as, but not limited to, Java®, Perl®, C®, C++®, PHP®, etc.

An Eclipse®-based product is a stand-alone program, e.g., self-contained and installable software application, built with the Eclipse® development platform. A product may optionally be packaged and delivered as one or more of so called features. A feature may correspond to a particular functionality of the product or the application, and usually groups a number of unitary software components that could be managed together as a single entity. According the terminology adopted in Eclipse® projects, such unitary software components are called plugins. The plugins are the basic installable and executable units or software code structures built by the Eclipse® developers.

By definition, products include all the code (e.g., plugins) needed to run the corresponding applications. For example, a product may include a newly developed Java® based application, a Java® Runtime Environment (JRE) and the Eclipse® platform code. The current Eclipse® provisioning platform p2® requires that the plugins, the JRE, and the necessary Eclipse® platform code have to be packaged and installed together as a single product. In one embodiment, instead of packaging the application plugins together with the JRE installation or with other base products necessary for the implementation of the application, only a reference to the base product could be included in the product installable package.

In one embodiment, the different elements of a product are described in a product descriptor, which for example, could be a text file of certain format. Based on the description of the product, the p2® provisioning mechanism builds installation package and publishes it in a p2® repository. The installation package includes artifacts (e.g, code or binaries) and metadata describing the artifacts, e.g., the relationships and dependencies between them, their default properties, etc.

In the terms of the p2® provisioning platform, installable unit (IU) describes a component that can be installed, updated and uninstalled. The IUs do not contain actual artifacts, but information or metadata about such artifacts, including names, versions, identifiers, dependencies, etc. IUs are generated for each of the plugins, the features included in the product, and even the product that should be installed. Usually, a product corresponds to a main or root IU, and the plugins are the peripheral or leaf IUs.

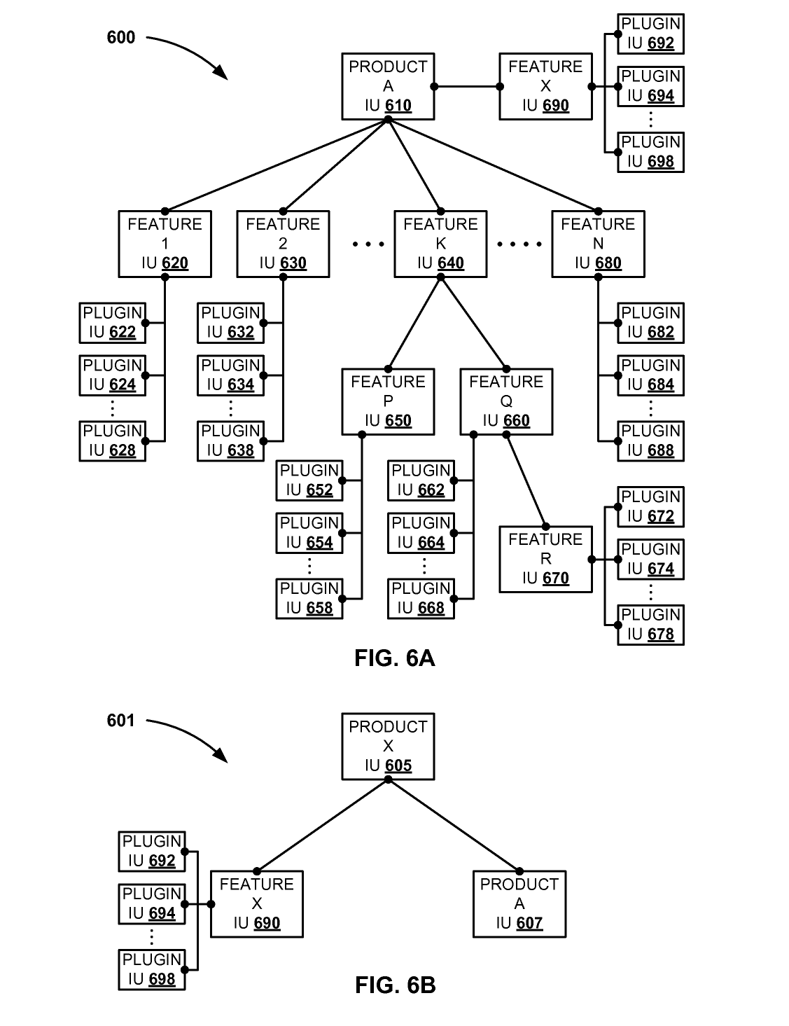

FIG. 6A shows a structure of IUs 600 corresponding to the metadata of a product installable package, according to one embodiment. Product ‘A’ IU 610 is the root IU of the installable package metadata of product ‘A’. For example, product ‘A’ IU 610 may correspond to product ‘A’ 210 in FIG. 2. Accordingly, the IUs 620 to 688 in FIG. 6A may correspond to the different components (functionalities and building blocks) 220 to 282 of product ‘A’ 210 in FIG. 2.

In one embodiment, based on the dependencies described in the IUs 620 to 688, a tree structure of the metadata of the installable package of product ‘A’ is created as illustrated in FIG. 6A. The product ‘A’ root IU 610 refers to feature ‘1’ IU 620, feature ‘2’ IU 630, feature ‘K’ IU 640 and feature ‘N’ IU 680. Feature ‘K’ IU 640 refers to feature ‘P’ IU 650 and to feature ‘Q’ IU 660. Further, feature ‘Q’ IU 660 refers to feature ‘R’ IU 670. These references specify dependencies or relationships between the functionalities corresponding to features of product ‘A’ as described in IUs 620, 630, 640, 650, 660, 670 and 680. The plugins described by plugin IUs 622 to 628, 632 to 638, 652 to 658, 662 to 668, 672 to 678 and 682 to 688 are grouped in the features corresponding to feature IUs 620, 630, 640, 650, 660, 670 and 680, accordingly. The relationships between the plugins and features of a product may form a graph structure different from a tree, where the IU corresponding to the product may still be on the highest hierarchical level.

Feature ‘X’ may be developed as an extension of product ‘A’, as illustrated in FIG. 2 with functionality ‘X’ 290 extending product ‘A’ 210. To include the new feature, the description, and respectively the metadata, of the existing product ‘A’ is redefined to include the new feature ‘X’ as illustrated with feature ‘X’ IU 690 referred by product ‘A’ IU 610 in FIG. 6A.

In one embodiment, to avoid redefinition of existing products, a new product ‘X’ is defined. As illustrated with the structure of IUs 601 shown in FIG. 6B, the installable package of the new product ‘X’ may include product ‘X’ IU 605 as a root installable object referring to the feature ‘X’ IU 690 corresponding to the new ‘X’ functionality. Plugins IU 692 to 698 in both FIG. 6A and FIG. 6B are the leaf IUs corresponding to the unitary components grouped by the application ‘X’. Further, the product ‘X’ IU 605 in FIG. 6B refers to product ‘A’ IU 607. Such nesting of product (e.g., root) IUs would allow the installation of product ‘A’ as a prerequisite to the installation of the feature ‘X’, e.g., using the p2® provisioning platform, according to one embodiment.

The metadata for a product, including the installable units, could be defined in one or more files stored in a repository. Virtually, any URL-accessible location, such as a remote server or local file system location could be an Eclipse® software repository. In one embodiment, a default implementation of the Eclipse® provisioning mechanism may assume a fixed-layout server. The content of an install repository for a product, e.g., in terms of IUs and corresponding features and plugins, may be described as metadata and plugin binaries. The metadata may be included in one or more index files in particular format. For example, the metadata may be described in XML files “content.xml” and “artifacts.xml” stored in the repository. The relevant plugin binaries could be also stored in the repository, e.g., in a subfolder of a main folder location where the metadata files are placed.

In one embodiment, an installable package of a product contains metadata and binaries that materialize a corresponding description of the product. Table 1 shows a simple description of a base product in XML format, according to Eclipse® adopted conventions. The description may be included in a file, e.g., named “myBaseProduct.product”:

TABLE 1
myBaseProduct.product

```
<?xml version=″1.0″ encoding=″UTF-8″?>
<?pde version=″3.5″?>
<product useFeatures=″false″ id=″myBaseProduct″>
    <configIni use=″default″>
    </configIni>
    <plugins>
      <plugin id=″MyBaseBundle″/>
    </plugins>
</product>
```

A tool in the p2® provisioning platform may generate the corresponding installable package for the base product and place it in a predefined location (repository). The below Table 2 and Table 3 show exemplary metadata included in files “content.xml” and “artifacts.xml”, respectively, corresponding to the description of the base product and necessary for its installation:

TABLE 2
content.xml

```
<?xml version=′1.0′ encoding=′UTF-8′?>
<?metadataRepository version=′1.1.0′?>
<repository name=′file:/C:/work/p2productExtension/ - metadata′
type=′org.eclipse.equinox.internal.p2.metadata.repository.LocalMetadataR
epository′ version=′1.0.0′>
  <properties size=′2′>
        <property name=′p2.timestamp′ value=′1331557011269′/>
        <property name=′p2.compressed′ value=′false′/>
  </properties>
  <units size=′8′>
      <unit id=′myBaseProduct′ version=′0.0.0′>
      <update id=′myBaseProduct′ range=′0.0.0′ severity=′0′/>
      <properties size=′3′>
          <property name=′org.eclipse.equinox.p2.name′
value=′myBaseProduct′/>
          <property name=′lineUp′ value=′true′/>
          <property name=′org.eclipse.equinox.p2.type.group′
value=′true′/>
        </properties>
        <provides size=′1′>
          <provided namespace=′org.eclipse.equinox.p2.iu′
name=′myBaseProduct′ version=′0.0.0′/>
        </provides>
        <requires size=′7′>
          <required namespace=′org.eclipse.equinox.p2.iu′
name=′tooling.source.default′ range=′[1.0.0,1.0.0]′/>
          <required namespace=′org.eclipse.equinox.p2.iu′
name=′a.jre.javase′ range=′[1.6.0,1.6.0]′/>
          <required namespace=′org.eclipse.equinox.p2.iu′
name=′toolingmyBaseProduct.configuration′ range=′raw:[−M,−M]′/>
          <required namespace=′org.eclipse.equinox.p2.iu′
name=′tooling.osgi.bundle.default′ range=′[1.0.0,1.0.0]′/>
          <required namespace=′org.eclipse.equinox.p2.iu′
name=′tooling.org.eclipse.update.feature.default′ range=′[1.0.0,1.0.0]′>
            <filter>
              (org.eclipse.update.install.features=true)
            </filter>
          </required>
          <required namespace=′org.eclipse.equinox.p2.iu′
name=′MyBaseBundle′ range=′[1.0.0.201203121430,1.0.0.201203121430]′/>
          <required namespace=′org.eclipse.equinox.p2.iu′
name=′config.a.jre.javase′ range=′[1.6.0,1.6.0]′/>
        </requires>
        <touchpoint id=′org.eclipse.equinox.p2.osgi′ version=′1.0.0′/>
      </unit>
      <unit id=′tooling.source.default′ version=′1.0.0′ singleton=′false′>
        <hostRequirements size=′1′>
          <required namespace=′org.eclipse.equinox.p2.eclipse.type′
name=′source′ range=′0.0.0′ optional=′true′ multiple=′true′
greedy=′false′/>
        </hostRequirements>
        <properties size=′1′>
          <property name=′org.eclipse.equinox.p2.type.fragment′
value=′true′/>
        </properties>
        <provides size=′2′>
          <provided namespace=′org.eclipse.equinox.p2.iu′
name=′tooling.source.default′ version=′1.0.0′/>
          <provided namespace=′org.eclipse.equinox.p2.flavor′
name=′tooling′ version=′1.0.0′/>
        </provides>
        <requires size=′1′>
          <required namespace=′org.eclipse.equinox.p2.eclipse.type′
name=′source′ range=′0.0.0′ optional=′true′ multiple=′true′
greedy=′false′/>
        </requires>
        <touchpoint id=′null′ version=′0.0.0′/>
        <touchpointData size=′1′>
          <instructions size=′2′>
            <instruction key=′install′>
              addSourceBundle(bundle:${artifact})
            </instruction>
            <instruction key=′uninstall′>
              removeSourceBundle(bundle:${artifact})
            </instruction>
          </instructions>
        </touchpointData>
      </unit>
      <unit id=′a.jre.javase′ version=′1.6.0′ singleton=′false′>
        <provides size=′159′>
          <provided namespace=′org.eclipse.equinox.p2.iu′
name=′a.jre.javase′ version=′1.6.0′/>
          <provided namespace=′java.package′ name=′javax.accessibility′
version=′0.0.0′/>
--------------- //jre installation metadata
        </provides>
        <touchpoint id=′org.eclipse.equinox.p2.native′ version=′1.0.0′/>
      </unit>
      <unit id=′toolingmyBaseProduct.configuration′ version=′0.0.0′>
        <provides size=′1′>
          <provided namespace=′org.eclipse.equinox.p2.iu′
name=′toolingmyBaseProduct.configuration′ version=′0.0.0′/>
        </provides>
        <touchpoint id=′null′ version=′0.0.0′/>
      </unit>
      <unit id=′tooling.osgi.bundle.default′ version=′1.0.0′
singleton=′false′>
        <hostRequirements size=′1′>
          <required namespace=′org.eclipse.equinox.p2.eclipse.type′
name=′bundle′ range=′0.0.0′ multiple=′true′ greedy=′false′/>
        </hostRequirements>
        <properties size=′1′>
          <property name=′org.eclipse.equinox.p2.type.fragment′
value=′true′/>
        </properties>
        <provides size=′2′>
          <provided namespace=′org.eclipse.equinox.p2.iu′
name=′tooling.osgi.bundle.default′ version=′1.0.0′/>
          <provided namespace=′org.eclipse.equinox.p2.flavor′
name=′tooling′ version=′1.0.0′/>
        </provides>
        <requires size=′1′>
          <required namespace=′org.eclipse.equinox.p2.eclipse.type′
name=′bundle′ range=′0.0.0′ multiple=′true′ greedy=′false′/>
        </requires>
        <touchpoint id=′null′ version=′0.0.0′/>
        <touchpointData size=′1′>
          <instructions size=′4′>
            <instruction key=′install′>
              installBundle(bundle:${artifact})
            </instruction>
            <instruction key=′uninstall′>
              uninstallBundle(bundle:${artifact})
            </instruction>
            <instruction key=′unconfigure′>
            </instruction>
            <instruction key=′configure′>
              setStartLevel(startLeve1:4);
            </instruction>
          </instructions>
        </touchpointData>
      </unit>
      <unit id=′tooling.org.eclipse.update.feature.default′
version=′1.0.0′ singleton=′false′>
        <hostRequirements size=′1′>
          <required namespace=′org.eclipse.equinox.p2.eclipse.type′
name=′feature′ range=′0.0.0′ optional=′true′ multiple=′true′
greedy=′false′/>
        </hostRequirements>
        <properties size=′1′>
          <property name=′org.eclipse.equinox.p2.type.fragment′
value=′true′/>
        </properties>
        <provides size=′2′>
          <provided namespace=′org.eclipse.equinox.p2.iu′
name=′tooling.org.eclipse.update.feature.default′ version=′1.0.0′/>
          <provided namespace=′org.eclipse.equinox.p2.flavor′
name=′tooling′ version=′1.0.0′/>
        </provides>
        <requires size=′1′>
          <required namespace=′org.eclipse.equinox.p2.eclipse.type′
name=′feature′ range=′0.0.0′ optional=′true′ multiple=′true′
greedy=′false′/>
        </requires>
        <filter>
          (org.eclipse.update.install.features=true)
        </filter>
        <touchpoint id=′null′ version=′0.0.0′/>
        <touchpointData size=′1′>
          <instructions size=′2′>
            <instruction key=′install′>
installFeature(feature:${artifact},featureId:default,featureVersion:defa
ult)
            </instruction>
            <instruction key=′uninstall′>
uninstallFeature(feature:${artifact},featureId:default,featureVersion:de
fault)
            </instruction>
          </instructions>
        </touchpointData>
      </unit>
      <unit id=′MyBaseBundle′ version=′1.0.0.201203121430′
singleton=′false′>
        <update id=′MyBaseBundle′ range=′[0.0.0,1.0.0.201203121430]′
severity=′0′/>
        <properties size=′1′>
          <property name=′org.eclipse.equinox.p2.name′
value=′MyBaseBundle′/>
        </properties>
        <provides size=′3′>
          <provided namespace=′org.eclipse.equinox.p2.iu′
name=′MyBaseBundle′ version=′1.0.0.201203121430′/>
          <provided namespace=′osgi.bundle′ name=′MyBaseBundle′
version=′1.0.0.201203121430′/>
          <provided namespace=′org.eclipse.equinox.p2.eclipse.type′
name=′bundle′ version=′1.0.0′/>
        </provides>
        <artifacts size=′1′>
          <artifact classifier=′osgi.bundle′ id=′MyBaseBundle′
version=′1.0.0.201203121430′/>
        </artifacts>
        <touchpoint id=′org.eclipse.equinox.p2.osgi′ version=′1.0.0′/>
        <touchpointData size=′1′>
          <instructions size=′1′>
            <instruction key=′manifest′>
              Bundle-SymbolicName: MyBaseBundle&#xA;Bundle-Version:
1.0.0.201203121430
            </instruction>
          </instructions>
        </touchpointData>
      </unit>
      <unit id=′config.a.jre.javase′ version=′1.6.0′ singleton=′false′>
        <hostRequirements size=′1′>
          <required namespace=′org.eclipse.equinox.p2.iu′
name=′a.jre.javase′ range=′1.6.0′/>
        </hostRequirements>
        <properties size=′1′>
          <property name=′org.eclipse.equinox.p2.type.fragment′
value=′true′/>
        </properties>
        <provides size=′1′>
          <provided namespace=′org.eclipse.equinox.p2.iu′
name=′config.a.jre.javase′ version=′1.6.0′/>
        </provides>
        <requires size=′1′>
          <required namespace=′org.eclipse.equinox.p2.iu′
name=′a.jre.javase′ range=′1.6.0′/>
        </requires>
        <touchpoint id=′org.eclipse.equinox.p2.native′ version=′1.0.0′/>
        <touchpointData size=′1′>
          <instructions size=′1′>
            <instruction key=′install′>
            </instruction>
          </instructions>
        </touchpointData>
      </unit>
  </units>
</repository>
```

TABLE 3
artifacts.xml

```
<?xml version=′1.0′ encoding=′UTF-8′?>
<?artifactRepository version=′1.1.0′?>
<repository name=′file:/C:/work/p2productExtension/ - artifacts′
type=′org.eclipse.equinox.p2.artifact.repository.simpleRepository′
version=′1.0.0′>
  <properties size=′2′>
      <property name=′p2.timestamp′ value=′1331557011260′/>
      <property name=′p2.compressed′ value=′false′/>
  </properties>
  <mappings size=′3′>
      <rule filter=′(&amp; (classifier=osgi.bundle))′
output=′${repoUrl}/plugins/${id}_${version}.jar′/>
      <rule filter=′(&amp; (classifier=binary))′
output=′${repoUrl}/binary/${id}_${version}′/>
      <rule filter=′(&amp; (classifier=org.eclipse.update.feature))′
output=′${repoUrl}/features/${id}_${version}.jar′/>
  </mappings>
  <artifacts size=′1′>
      <artifact classifier=′osgi.bundle′ id=′MyBaseBundle′
version=′1.0.0.201203121430′>
        <properties size=′3′>
          <property name=′artifact.size′ value=′364′/>
          <property name=′download.size′ value=′364′/>
          <property name=′download.md5′
value=′39151ec5c2631125b4a3a0bd395c9dfb′/>
        </properties>
      </artifact>
  </artifacts>
</repository>
```

As illustrated in Table 2, the “content.xml” file describes the installable units with their dependencies and configurations. The described IUs correspond to the base product, features and plugins, respectively. The “artifacts.xml” file includes metadata regarding the installable code, e.g., the binary file (or files) corresponding to the product components. As Table 3 shows, the artifacts may be developed in the terms of the Open Services Gateway initiative (OSGi) framework. The actual artifact binaries (e.g., OSGi bundle file “MyBaseBundle_{—}1.0.0.201203121430.jar”, according to the definition in Table 3), may be stored in a “plugins” subfolder of the location of the metadata files.

When an application is developed to include features or functionality provided by the base product, a new product may be defined to frame or brand the new application and the base product, according to one embodiment. Table 4 shows the content of file “myExtendedProduct.product” describing the new product in XML format:

TABLE 4
myExtendedProduct.product

```
<?xml version=″1.0″ encoding=″UTF-8″?>
<?pde version=″3.5″?>
<product useFeatures=″false″ id=″myAdditionalProduct″>
    <configIni use=″default″>
    </configIni>
    <plugins>
        <plugin id=″MyAdditionalBundle″/>
    </plugins>
</product>
```

In one embodiment, the connection between the new or extended product and the base product may be defined with an additional entry in the product file (“myExtendedProduct.product”). Alternatively, the reference to the base product may be included in an additional descriptor file, e.g., file “p2.inf”, as shown in Table 5:

TABLE 5
p2.inf

requires.0.name = myBaseProduct
requires.0.namespace = org.eclipse.equinox.p2.iu
requires.0.range = 0.0.0

Based on the description of the extended product and the link to the base product provided in files “myExtendedProduct.product” and “p2.inf”, respectively, a corresponding installable package for the extended product is generated, e.g., by the means of the p2® provisioning platform, and placed at a predefined location. The below Table 6 and Table 7 show exemplary metadata files “content.xml” and “artifacts.xml”, respectively, necessary for the installation of the extended product:

TABLE 6
content.xml

```
<?xml version=′1.0′ encoding=′UTF-8′?>
<?metadataRepository version=′1.1.0′?>
<repository name=′file:/C:/work/p2productExtension/extended/ - metadata′
type=′org.eclipse.equinox.internal.p2.metadata.repository.LocalMetadataR
epository′ version=′1.0.0′>
  <properties size=′2′>
      <property name=′p2.timestamp′ value=′1331557616048′/>
      <property name=′p2.compressed′ value=′false′/>
  </properties>
  <units size=′8′>
      <unit id=′myAdditionalProduct′ version=′0.0.0′>
        <update id=′myAdditionalProduct′ range=′0.0.0′ severity=′0′/>
        <properties size=′3′>
          <property name=′org.eclipse.equinox.p2.name′
value=′myAdditionalProduct′/>
          <property name=′lineUp′ value=′true′/>
          <property name=′org.eclipse.equinox.p2.type.group′
value=′true′/>
        </properties>
        <provides size=′1′>
          <provided namespace=′org.eclipse.equinox.p2.iu′
name=′myAdditionalProduct′ version=′0.0.0′/>
        </provides>
        <requires size=′8′>
          <required namespace=′org.eclipse.equinox.p2.iu′
name=′myBaseProduct′ range=′0.0.0′/>
          <required namespace=′org.eclipse.equinox.p2.iu′
name=′MyAdditionalBundle′
range=′[1.0.0.201203121459,1.0.0.201203121459]′/>
          <required namespace=′org.eclipse.equinox.p2.iu′
name=′config.a.jre.javase′ range=′[1.6.0,1.6.0]′/>
          <required namespace=′org.eclipse.equinox.p2.iu′
name=′tooling.org.eclipse.update.feature.default′ range=′[1.0.0,1.0.0]′>
            <filter>
              (org.eclipse.update.install.features=true)
            </filter>
          </required>
          <required namespace=′org.eclipse.equinox.p2.iu′
name=′a.jre.javase′ range=′[1.6.0,1.6.0]′/>
          <required namespace=′org.eclipse.equinox.p2.iu′
name=′tooling.source.default′ range=′[1.0.0,1.0.0]′/>
          <required namespace=′org.eclipse.equinox.p2.iu′
name=′tooling.osgi.bundle.default′ range=′[1.0.0,1.0.0]′/>
          <required namespace=′org.eclipse.equinox.p2.iu′
name=′toolingmyAdditionalProduct.configuration′ range=′raw:[−M,−M]′/>
        </requires>
        <touchpoint id=′org.eclipse.equinox.p2.osgi′ version=′1.0.0′/>
        <touchpointData size=′1′/>
      </unit>
      <unit id=′toolingmyAdditionalProduct.configuration′ version=′0.0.0′>
        <provides size=′1′>
          <provided namespace=′org.eclipse.equinox.p2.iu′
name=′toolingmyAdditionalProduct.configuration′ version=′0.0.0′/>
        </provides>
        <touchpoint id=′null′ version=′0.0.0′/>
      </unit>
      <unit id=′MyAdditionalBundle′ version=′1.0.0.201203121459′
singleton=′false′>
        <update id=′MyAdditionalBundle′ range=′[0.0.0,1.0.0.201203121459]′
severity=′0′/>
        <properties size=′1′>
          <property name=′org.eclipse.equinox.p2.name′
value=′MyAdditionalBundle′/>
        </properties>
        <provides size=′3′>
          <provided namespace=′org.eclipse.equinox.p2.iu′
name=′MyAdditionalBundle′ version=′1.0.0.201203121459′/>
          <provided namespace=′osgi.bundle′ name=′MyAdditionalBundle′
version=′1.0.0.201203121459′/>
          <provided namespace=′org.eclipse.equinox.p2.eclipse.type′
name=′bundle′ version=′1.0.0′/>
        </provides>
        <artifacts size=′1′>
          <artifact classifier=′osgi.bundle′ id=′MyAdditionalBundle′
version=′1.0.0.201203121459′/>
        </artifacts>
        <touchpoint id=′org.eclipse.equinox.p2.osgi′ version=′1.0.0′/>
        <touchpointData size=′1′>
          <instructions size=′1′>
            <instruction key=′manifest′>
              Bundle-SymbolicName: MyAdditionalBundle&#xA;Bundle-Version:
1.0.0.201203121459
            </instruction>
          </instructions>
        </touchpointData>
      </unit>
  </units>
</repository>
```

TABLE 7
artifacts.xml

```
<?xml version=′1.0′ encoding=′UTF-8′?>
<?artifactRepository version=′1.1.0′?>
<repository name=′file:/C:/work/p2productExtension/extended/ -
artifacts′
type=′org.eclipse.equinox.p2.artifact.repository.simpleRepository′
version=′1.0.0′>
  <properties size=′2′>
      <property name=′p2.timestamp′ value=′1331557616038′/>
      <property name=′p2.compressed′ value=′false′/>
  </properties>
  <mappings size=′3′>
      <rule filter=′(&amp; (classifier=osgi.bundle))′
output=′${repoUrl}/plugins/${id}_${version}.jar′/>
      <rule filter=′(&amp; (classifier=binary))′
output=′${repoUrl}/binary/${id}_${version}′/>
      <rule filter=′(&amp; (classifier=org.eclipse.update.feature))′
output=′${repoUrl}/features/${id}_${version}.jar′/>
  </mappings>
  <artifacts size=′1′>
      <artifact classifier=′osgi.bundle′ id=′MyAdditionalBundle′
version=′1.0.0.201203121459′>
        <properties size=′3′>
          <property name=′artifact.size′ value=′370′/>
          <property name=′download.size′ value=′370′/>
          <property name=′download.md5′
value=′45634150971b75f10d928c760601432e′/>
        </properties>
      </artifact>
  </artifacts>
</repository>
```

As illustrated in Table 6, the “content.xml” file describes the installable units and configurations corresponding to the extended (additional) product, and its features and plugins. In one embodiment, the metadata for the installable package of the new product contained in file “content.xml” includes a reference to the base product. The described functionalities of the base product, e.g., the installable units, may not be duplicated in the metadata of the extended product. The “artifacts.xml” file in Table 7 includes metadata regarding the installable code, e.g., a reference to the binary file “MyAdditionalBundle_{—}1.0.0.201203121459.jar” stored in a subfolder of the location of files “content.xml” and “artifacts.xml”.

In one embodiment, the repository of the extended product may contain only the extension, e.g., the delta (the difference) between the extended product and the base product, and may not be self-contained. Alternatively, the installable package of the extended product may be combined or stored together with the installable package of the base product in a same, self-contained repository.

In one embodiment, an installation mechanism of the Eclipse® platform installs the extended product by accessing both installable packages at their corresponding locations. Thus, the installation of the base product is nested in the installation of the extended product as prerequisite for the installation of the new functionality which extends the base product. In one embodiment, an additional, e.g., composite, repository is created to provide additional metadata to an Eclipse® install tool used by a customer to install the extended product as a composite product. The metadata of the composite repository may include reference to the extended product repository. Table 8 and Table 9 show the content of files “compositeContent.xml” and “compositeArtifacts.xml” representing the metadata kept in the composite repository regarding the composite product installable units and artifacts, respectively:

TABLE 8
compsiteContent.xml

```
<?xml version=′1.0′ encoding=′UTF-8′?>
<?compositeMetadataRepository version=′1.0.0′?>
<repository name=′&quot;Extended product Site&quot;′
type=′org.eclipse.equinox.internal.p2.metadata.repository.CompositeMetad
ataRepository′ version=′1.0.0′>
  <properties size=′1′>
      <property name=′p2.timestamp′ value=′1243822502499′/>
  </properties>
  <children size=′2′>
      <child location=′addons′/>
      <child location=′base′/>
  </children>
</repository>
```

TABLE 9
compositeArtifacts.xml

```
<?xml version=′1.0′ encoding=′UTF-8′?>
<?compositeArtifactRepository version=′1.0.0′?>
<repository name=′&quot;Extended product Site&quot;′
type=′org.eclipse.equinox.internal.p2.artifact.repository.CompositeArtif
actRepository′ version=′1.0.0′>
  <properties size=′1′>
      <property name=′p2.timestamp′ value=′1243822502440′/>
  </properties>
  <children size=′2′>
      <child location=′addons′/>
      <child location=′base′/>
  </children>
</repository>
```

In one embodiment, the metadata in the composite repository may provide links to the install repository of the base product as well. The Eclipse® based install tool utilized by the customer uses the information included in files “compositeContent.xml” and “compositeArtifacts.xml” to locate the metadata and artifacts of both the extended and the base products to perform the nested product installation.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

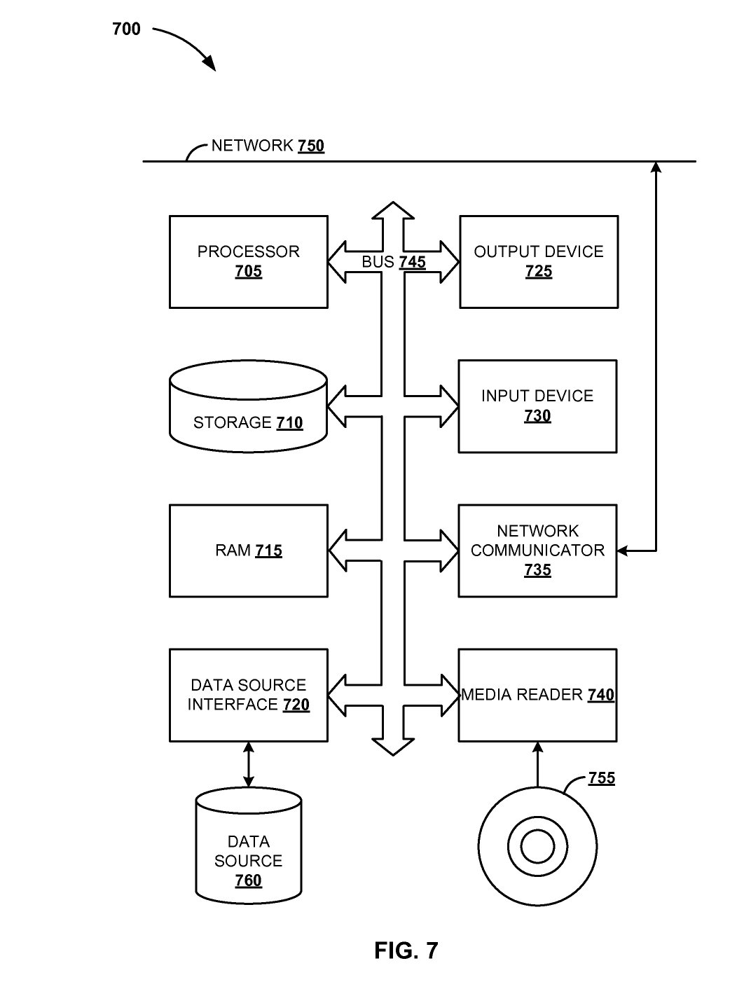

FIG. 7 is a block diagram of an exemplary computer system 700. The computer system 700 includes a processor 705 that executes software instructions or code stored on a computer readable storage medium 755 to perform the above-illustrated methods. The computer system 700 includes a media reader 740 to read the instructions from the computer readable storage medium 755 and store the instructions in storage 710 or in random access memory (RAM) 715. The storage 710 provides a large space for keeping static data where at least some instructions could be stored for later execution. The stored instructions may be further compiled to generate other representations of the instructions and dynamically stored in the RAM 715. The processor 705 reads instructions from the RAM 715 and performs actions as instructed. According to one embodiment, the computer system 700 further includes an output device 725 (e.g., a display) to provide at least some of the results of the execution as output including, but not limited to, visual information to users and an input device 730 to provide a user or another device with means for entering data and/or otherwise interact with the computer system 700. Each of these output devices 725 and input devices 730 could be joined by one or more additional peripherals to further expand the capabilities of the computer system 700. A network communicator 735 may be provided to connect the computer system 700 to a network 750 and in turn to other devices connected to the network 750 including other clients, servers, data stores, and interfaces, for instance. The modules of the computer system 700 are interconnected via a bus 745. Computer system 700 includes a data source interface 720 to access data source 760. The data source 760 can be accessed via one or more abstraction layers implemented in hardware or software. For example, the data source 760 may be accessed via network 750. In some embodiments the data source 760 may be accessed by an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the presented embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limiting to the precise forms disclosed. While specific embodiments and examples are described herein for illustrative purposes, various equivalent modifications are possible, as those skilled in the relevant art will recognize. These modifications can be made in light of the above detailed description. Rather, the scope of the specification is to be determined by the following claims, which are to be interpreted in accordance with established doctrines of claim construction.

What is claimed is:

1. A computer system for nesting installations of standalone software products, the system comprising:
a memory to store computer executable instructions; and
a processor coupled to the memory and operable to execute the instructions to generate:
a definition of a first product including a reference to an application extending a functionality of a second product, and a reference to the second product;
an installable package for the first product based on the definition of the first product, wherein the installable package of the first product includes software code corresponding to the application and a reference to an installable package of the second product; and
a repository to store the installable package for the first product on a network location available to a customer for installation.

2. The system of claim 1, wherein the definition of the first product comprises:
a first file containing a reference to the application extending the second product; and
a second file containing a reference to the second product.

3. The system of claim 1, wherein the installable package of the first product comprises:
a plurality of component descriptions defining a plurality of components of the first product, wherein at least one component description of the plurality of component descriptions is assigned to the application, and wherein at least one component description of the plurality of component descriptions is assigned to the second product; and
a plurality of relationships between the plurality of component descriptions, wherein the plurality of relationships correspond to a tree structure with a root node corresponding to a component description assigned to the first product.

4. The system of claim 3, wherein the plurality of component descriptions comprises:
a configuration of the plurality of components of the first product to setup one or more installation characteristics, execution characteristics and update characteristics of the application; and
a reconfiguration of one or more components of the second product to setup one or more execution characteristics of the second product.

5. The system of claim 1, wherein the repository storing the installable package of the first product comprises:
a composite repository to store a reference to the repository storing the installable package of the first product and a reference to a repository storing the installable package of the second product.

6. A non-transitory computer-readable medium storing instructions, which when executed cause a computer system to:
generate a definition of a new software product;
include a new functionality specific to the new software product in the definition of the new software product;
create a reference to a base software product providing base functionality prerequisite for executing the new functionality of the new software product;
generate an installable package for the new software product based on the definition of the new software product, where the installable package includes software code for the new functionality and a reference to an installable package of the base software product; and
publish the installable package for the new software product on a public network location.

7. The computer readable media of claim 6, wherein creating the reference to the base software product comprises one or more of:
including at least partially the reference to the base software product in the definition of the new software product; and
creating a separate definition including at least partially the reference to the base software product.

8. The computer readable media of claim 6, wherein generating the installable package for the new software product comprises:
generating metadata including a plurality of installable units of the new software product, wherein at least a first installable unit of the plurality of installable units assigns the new functionality, and wherein at least a second installable unit of the plurality of installable units assigns the base software product.

9. The computer readable media of claim 8 storing further instructions, which when executed cause a computer system further to:
identify at least one artifact from a pool of artifacts based on the at least first installable unit of the plurality of installable units; and
fetch the at least one artifact from a pool of artifacts to the software code.

10. The computer readable media of claim 8, wherein generating the metadata comprises:
defining a plurality of relationships between the plurality of installable units corresponding to a hierarchical structure with a root installable unit assigning the new software product, wherein the at least first installable unit and the at least second installable unit are subordinate to the root installable unit.

11. The computer readable media of claim 8, wherein generating the metadata comprises:
generating a configuration of the at least first installable unit to setup one or more of installation characteristics, execution characteristics and update characteristics of the new functionality; and
generating a reconfiguration of the at least second installable unit, wherein the reconfiguration specifies one or more execution characteristics of the base software product overwriting a base configuration in the installable package of the base software product.

12. The computer readable media of claim 6, wherein generating the installable package comprises:
storing the software code in at least one binary file including a plurality of artifacts corresponding to the new functionality.

13. The computer readable media of claim 6, wherein publishing the installable package for the new software product comprises:
generating a composite software product repository storing metadata referring to a repository storing the installable package of the new software product and to a repository storing the installable package of the base software product.

14. A computer implemented method for nesting installations of a plurality of software products, the method comprising:
receiving a definition of a new computer application built upon a base software product;
creating in a memory a description of an extended software product including the new computer application;
creating a reference to the base software product; and
generating by a processor an installable package based on the description of the extended software product, wherein the installable package includes software code corresponding to the new computer application, and where the installable package further includes a reference to at least one installable package corresponding to the base software product.

15. The method of claim 14 further comprising:
publishing the installable package on a network location accessible by at least one customer.

16. The method of claim 14, wherein creating the reference to the base software product comprises one or more of:
including at least partially the reference to the base software product in the description of the extended software product; and
creating in the memory a second description including at least partially the reference to the base software product.

17. The method of claim 14, wherein generating the installable package based on the description of the extended software product comprises:
describing a plurality of components of the extended software product, wherein at least a first component of the plurality of components corresponds to the new computer application, and wherein at least a second component of the plurality of components corresponds to the base software product.

18. The method of claim 17, further comprising:
identifying at least one computer program artifact from a plurality of computer program artifacts based on a description of the at least first component of the plurality of components; and
fetching the at least one computer program artifact to the software code.

19. The method of claim 17, wherein generating the metadata comprises:
analyzing a plurality of relationships between the plurality of components to generate a hierarchical structure, wherein a component of the plurality of components corresponding to the extended software product is a root component, and wherein the at least first component and the at least second component are subordinate to the root component.

20. The method of claim 17, wherein generating the metadata comprises:
generating at least one configuration of the at least first component of the plurality of described components, wherein the at least one configuration setups one or more of installation characteristics, execution characteristics and update characteristics of the new computer application; and
generating at least one reconfiguration of the at least second component of the plurality of described components, wherein the at least one reconfiguration specifies one or more execution characteristics of the base software product.
